(19) United States
(12) Patent Application Publication
(10) Pub. No.: US 2023/0084562 A1
(43) Pub. Date: Mar. 16, 2023

(54) NON-DESTRUCTIVE INSPECTION METHOD AND SYSTEM BASED ON ARTIFICIAL INTELLIGENCE

(71) Applicant: POWER INS CO., LTD., Daejeon (KR)

(72) Inventor: Sang Ki PARK, Daejeon (KR)

(73) Assignee: POWER INS CO., LTD., Daejeon (KR)

(21) Appl. No.: 17/977,188

(22) Filed: Oct. 31, 2022

Related U.S. Application Data
(63) Continuation of application No. PCT/KR2020/012601, filed on Sep. 18, 2020.

(30) Foreign Application Priority Data
Jun. 24, 2020 (KR) 10-2020-0077034

(51) Int. Cl. G06T 7/00; G06T 7/73

(52) U.S. Cl. CPC G06T 7/0004; G06T 7/73; G06T 2207/20081; G06T 2207/20084; G06T 2207/30164

(57) ABSTRACT

Provided are a non-destructive inspection system and a non-destructive inspection method both based on an artificial intelligence (AI) model. The non-destructive inspection system based on an AI model for determining a defect of an inspection object includes an image input unit configured to receive inspection signal image data of the inspection object, a first AI model unit configured to extract one or more feature portions for determining a defect of the inspection object from the inspection signal image data, and a second AI model unit configured to generate node relationship information by converting each of the feature portions into a node and learn based on the node relationship information to determine a defect in the inspection object.

### CROSS-REFERENCE TO RELATED APPLICATIONS

This application is a continuation of International Application No. PCT/KR2020/012601 filed on Sep. 18, 2020, which claims priority to Korean Patent Application No. 10-2020-0077034 filed on Jun. 24, 2020, the entire contents of which are herein incorporated by reference.

### TECHNICAL FIELD

The present disclosure relates to a non-destructive inspection system and a non-destructive inspection method both based on an artificial intelligence (AI) model. More particularly, the present disclosure relates to a non-destructive inspection system and a non-destructive inspection method both based on an AI model, by which, by using a plurality of AI models, a feature portion for determining a defect of an inspection object is extracted from received inspection signal image data of the input inspection object, and node relationship information for the extracted feature portion is generated to determine a defect of the inspection object.

### BACKGROUND ART

In non-destructive inspection, a defect is detected from an inspection object such as equipment by using physical characteristics such as ultrasounds, electromagnetism, radiation, and eddy current. Examples of the non-destructive inspection include liquid penetrant examination, magnetic particle testing, radiographic testing, ultrasonic testing, and eddy current testing.

In general, a system for determining the stability of an inspection object by using non-destructive inspection is a visual inspection system in which an inspector directly performs inspection by using a probe and sees a result of the inspection and directly determines the stability. The visual inspection system takes a lot of time, and the precision of the inspection result is low. In addition, the reliability of the inspection is lowered because the inspection result changes every time according to a difference in human factors such as the skill and experience of the inspector.

For example, in the stability inspection of a turbine rotor performed in power plants, because a turbine blade root part is combined with rotor blades, visual inspection is impossible without disassembling them. Therefore, an ultrasonic testing method of radiating ultrasonic waves to a turbine blade root part to performing testing is used. In this case, because the ultrasonic testing is performed by an inspector directly entering narrow spaces between turbine blades and acquiring ultrasonic signals, the testing takes a long time in many cases. In this case, power generation of a power plant is stopped during testing, resulting in huge costs. Moreover, because the inspector directly reads the acquired ultrasonic signals, a reading result often varies depending on inspectors. In this case, testing is re-performed, and accordingly, an operation stop time is increased.

### DESCRIPTION OF EMBODIMENTS

### Technical Problem

Provided are a non-destructive inspection system and a non-destructive inspection method both based on an artificial intelligence (AI) model, which are capable of reducing a difference between inspection results generable due to human factors and improving the quality of detection of defects in an inspection object.

Provided are a non-destructive inspection system and a non-destructive inspection method both based on an AI model, which are universally applicable to the field of non-destructive inspection based on evaluation of an image signal obtained by ultrasonic testing, eddy current testing, etc.

Provided are an AI-based non-destructive inspection method and an AI-based non-destructive inspection system, in which a non-destructive inspection object is estimated by analyzing the structure or characteristics of raw data from a non-destructive inspection device, and an AI model to be used for analysis is recommended.

Provided are an AI-based non-destructive inspection method and an AI-based non-destructive inspection system, in which, when scan data for a non-destructive inspection object is small, the amount of the scan data is amplified and the amplified scan data is used as training data for an AI model.

Provided are an AI-based non-destructive inspection method and an AI-based non-destructive inspection system, in which determination performance of an AI model is improved by allowing the AI model to learn the determination know-how of an experienced inspector.

The technical problems of the present disclosure are not limited to the above-mentioned contents, and other technical problems not mentioned will be clearly understood by a person skilled in the art from the following description.

### Technical Solution

According to an aspect of the present disclosure, a non-destructive inspection system based on an artificial intelligence (AI) model for determining a defect of an inspection object includes an image input unit configured to receive inspection signal image data of the inspection object, a first AI model unit configured to extract one or more feature portions for determining a defect of the inspection object from the inspection signal image data, and a second AI model unit configured to generate node relationship information by converting each of the feature portions into a node and learn based on the node relationship information to determine a defect in the inspection object.

The one or more feature portions may be determined based on output strengths of inspection signals in the inspection signal image data.

The first AI model unit may adjust the brightness of the inspection signal image data so that the one or more feature portions are emphasized.

The nodes may be generated by extracting rectangular regions respectively including the feature portions.

The second AI model unit may rescale the shapes of the nodes to square shapes.

The first AI model unit may emphasize the feature portions by using a deep neural network (DNN) in which a plurality of convolution layers are combined.

The node relationship information may include one or more of the number of nodes and relative location information between the nodes.

The second AI model unit may determine a defect of the object, based on the number of nodes in the node relationship information.

The second AI model unit may determine a defect of the object, based on the relative location information between the nodes in the node relationship information.

The second AI model unit may calculate distances between the nodes, and, when a largest value among values of the calculated distances between the nodes exceeds a pre-determined value, may determine that a defect exists in the inspection object.

According to another aspect of the present disclosure, a non-destructive inspection method based on an AI model for determining a defect of an inspection object includes an image reception operation of receiving inspection signal image data of the inspection object, a first AI model analysis operation of extracting one or more feature portions for determining a defect of the inspection object from the inspection signal image data, and a second AI model analysis operation of converting each of the feature portions into a node to generate node relationship information and learning based on the node relationship information to determine a defect in the inspection object.

The one or more feature portions may be determined based on output strengths of inspection signals in the inspection signal image data.

The first AI model analysis operation may include adjusting the brightness of the inspection signal image data so that the one or more feature portions are emphasized.

The nodes may be generated by extracting rectangular regions respectively including the feature portions.

The second AI model analysis operation may include rescaling the shapes of the nodes to square shapes.

The first AI model analysis operation may include emphasizing the feature portions by using a deep neural network (DNN) in which a plurality of convolution layers are combined.

The node relationship information may include one or more of the number of nodes and relative location information between the nodes.

The second AI model analysis operation may include determining a defect of the object, based on the number of nodes in the node relationship information.

The second AI model analysis operation may include determining a defect of the object, based on the relative location information between the nodes in the node relationship information.

The second AI model analysis operation may include calculating distances between the nodes, and, when a largest value among values of the calculated distances between the nodes exceeds a pre-determined value, determining that a defect exists in the inspection object.

According to another aspect of the present disclosure, an AI-based non-destructive inspection method includes inquiring the characteristics of raw data generated by a non-destructive inspection device, analyzing the characteristics of the raw data, estimating an object of non-destructive inspection according to the characteristics of the raw data, recommending an AI model suitable for the estimated object, and reviewing the stability of the object by using the recommended AI model.

The AI-based non-destructive inspection method may further include determining whether to amplify data for training the AI model recommended according to the characteristics of the raw data, and additionally generating the data according to a result of the amplification determination.

In the inquiring of the characteristics of the raw data, data parsing may be performed based on the raw data and the parsed data may be analyzed.

The characteristics of the raw data may include structure information of the data obtained by the non-destructive inspection device.

In the inquiring of the characteristics of the raw data, the characteristics of the raw data may be received from the non-destructive inspection device. In the recommending of the AI model, a suitable AI model may be recommended among a plurality of pre-registered AI models, based on the received characteristics of the raw data.

In the determining of whether to amplify data, it may be determined whether the data is amplified, according to whether the AI model is overfitted or how the determination accuracy is.

The non-destructive testing device may be an inspection device using ultrasonic waves, and, in the additionally generating of the data, the data may be additionally generated by calculating a movement average of adjacent measured values based on any one of a scan count axis, a measurement point axis, and an ultrasound index axis based on 3D data having the scan count axis, the measurement point axis, and the ultrasound index axis.

In the additionally generating of the data, a movement average length (window size) used for calculating the movement average may be adjusted according to the accuracy of the AI model.

The AI-based non-destructive testing method may further include requesting additional determination by an inspector according to the accuracy of the review result for the stability, updating the review result with a result of the additional determination by the inspector, and performing data labeling for adjusting the weight of the AI model, based on the updated review result.

The object may be a turbine blade.

According to another aspect of the present disclosure, an AI-based non-destructive inspection system includes a data collector configured to collect raw data generated by a non-destructive inspection device, a data analyzer configured to analyze the characteristics of the raw data and estimate an object of non-destructive inspection according to the characteristics of the raw data, a model recommendation unit configured to recommend an AI model suitable for the estimated object, and a stability review unit configured to review the stability of the object by using the recommended AI model.

The AI-based non-destructive inspection system may further include an amplification determiner configured to determine whether to amplify data for training the AI model recommended according to the characteristics of the raw data, and a preprocessor configured to additionally generate the data when the amplification is necessary.

The data analyzer may perform data parsing, based on the raw data, and may analyze the parsed data.

The characteristics of the raw data may include structure information of the data obtained by the non-destructive inspection device.

The data analyzer may receive the characteristics of the raw data from the non-destructive inspection device. The model recommendation unit may recommend a suitable AI model among a plurality of pre-registered AI models, based on the received characteristics of the raw data.

The amplification determiner may determine whether to amplify data, according to whether the AI model is overfitted or how the determination accuracy is.

The non-destructive testing device may be an inspection device using ultrasonic waves, and the preprocessor may additionally generate the data by calculating a movement average of adjacent measured values based on any one of a scan count axis, a measurement point axis, and an ultrasound index axis based on 3D data having the scan count axis, the measurement point axis, and the ultrasound index axis.

The preprocessor may adjust a movement average length (window size) used for calculating the movement average, according to the accuracy of the AI model.

The AI-based non-destructive testing system may further include a stability diagnosis result report unit configured to request additional determination by an inspector according to the accuracy of the review result for the stability and update the review result with a result of the additional determination by the inspector, and a label edition unit configured to perform data labeling for adjusting the weight of the AI model, based on the updated review result.

The object may be a turbine blade.

### Effects of Disclosure

A non-destructive inspection system and a non-destructive inspection method both based on an artificial intelligence (AI) model, according to an embodiment of the present disclosure, may reduce a difference between inspection results generable due to human factors, and may improve the quality of detection of defects in an inspection object.

In addition, the non-destructive inspection system and the non-destructive inspection method both based on an AI model are universally applicable to all types of non-destructive inspection in which an image signal is obtained.

In an AI-based non-destructive inspection method and an AI-based non-destructive inspection system, according to an embodiment of the present disclosure, a non-destructive inspection object may be estimated by analyzing the structure or characteristics of raw data from a non-destructive inspection device, and an AI model to be used for analysis may be recommended.

In the AI-based non-destructive inspection method and the AI-based non-destructive inspection system, when scan data for a non-destructive inspection object is small, the amount of the scan data may be amplified, and the amplified scan data may be used as training data for an AI model.

The AI-based non-destructive inspection system and the AI-based non-destructive inspection method may improve determination performance of the AI model by allowing the AI model to learn the determination know-how of an experienced inspector.

In the AI-based non-destructive inspection system and the AI-based non-destructive inspection method, stability of the non-destructive inspection object may be determined using the AI model having improved determination performance.

The effects of the present disclosure are not limited to the above-mentioned contents, and other effects not mentioned will be clearly understood by a person skilled in the art from the following description.

### BRIEF DESCRIPTION OF THE DRAWINGS

FIG. 1A is a view illustrating inspection signal image data of an inspection object without defects, according to an embodiment of the present disclosure, and

FIG. 1B is a view illustrating inspection signal image data of an inspection object with defects, according to an embodiment of the present disclosure.

FIG. 2 is a block diagram of a non-destructive inspection system using an artificial intelligence (AI) model, according to an embodiment of the present disclosure.

FIG. 3 is a view illustrating a processing procedure of the non-destructive inspection system using an AI model, according to an embodiment of the present disclosure.

FIG. 4 is a diagram illustrating a first AI model of a non-destructive inspection system based on an AI model according to an embodiment of the present disclosure.

FIG. 5 illustrates a determination flow of a second AI model unit with respect to a defect of an inspection object, according to an embodiment of the present disclosure.

FIGS. 6A and 6B are views illustrating different inspection signal image data for the same inspection object in the conventional art.

FIG. 7 is a flowchart of a non-destructive inspection method based on an AI model, according to an embodiment of the present disclosure.

FIG. 8 illustrates ultrasound waveforms and image signals obtained by visualizing signals acquired by a conventional ultrasonic testing device.

FIG. 9 is a block diagram of an AI-based non-destructive inspection system according to an embodiment of the present disclosure and its internal structure.

FIG. 10 is a view illustrating a raw data structure of a non-destructive inspection device according to an embodiment of the present disclosure.

FIG. 11 is a diagram illustrating a three-dimensional (3D) data structure that a data collector collects from raw data, according to an embodiment of the present disclosure.

FIG. 12 is a view illustrating a measurement point of a probe with respect to a non-destructive inspection object according to an embodiment of the present disclosure.

FIG. 13 is a diagram illustrating a movement average calculation concept according to an embodiment of the present disclosure.

FIG. 14 is a diagram illustrating data amplification using a movement average in a 3D data structure according to an embodiment of the present disclosure.

FIGS. 15 through 17 are flowcharts of an AI-based non-destructive inspection method according to an embodiment of the present disclosure.

### MODE OF DISCLOSURE

Embodiments of the present disclosure will now be described more fully with reference to the accompanying drawings such that one of ordinary skill in the art to which the present disclosure pertains may easily execute the present disclosure. The present disclosure may, however, be embodied in many different forms and should not be construed as being limited to the embodiments set forth herein. In the drawings, elements irrelevant to the descriptions of the present disclosure are omitted to clearly explain embodiments of the present disclosure.

The terms used in the present specification are merely used to describe particular embodiments, and are not intended to limit the present disclosure. An expression used in the singular may encompass the expression of the plural, unless it has a clearly different meaning in the context.

In the present specification, it may be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the present disclosure are shown independently to indicate different characteristic functions, and do not mean that each component is separate hardware or one software component. In other words, for convenience of description, each component is listed and described as each component, and at least two components of each component may be combined to form one component, or one component may be divided into a plurality of components to perform a function. The integrated and separate embodiments of each component are also included in the scope of the present disclosure without departing from the essence of the present disclosure.

In addition, the following embodiments are provided to more clearly explain the present disclosure to one of ordinary skill in the art, and the shapes and sizes of elements in the drawings may be exaggerated for more clear description.

An embodiment to be described below is described as an embodiment for ultrasonic testing on turbine blades of a power plant, but the present disclosure is not limited thereto. The present disclosure is applicable to an apparatus and method of performing general non-destructive inspection.

Hereinafter, the present disclosure will be described more fully with reference to the accompanying drawings, in which embodiments of the present disclosure are shown.

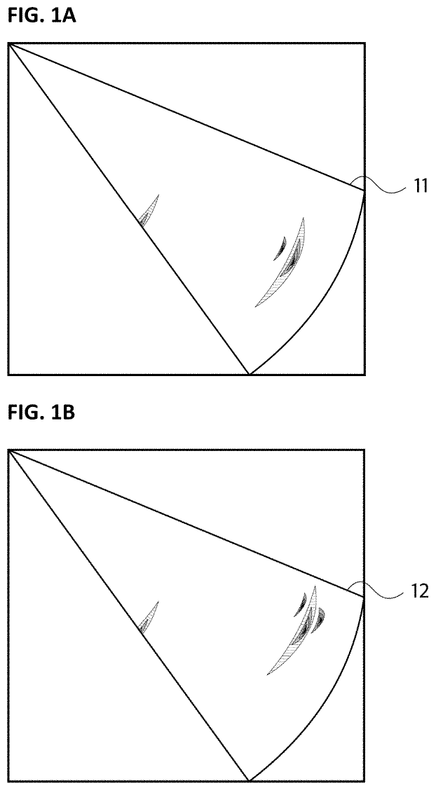

FIG. 1 (a) is a view illustrating inspection signal image data of an inspection object without defects, according to an embodiment of the present disclosure, and

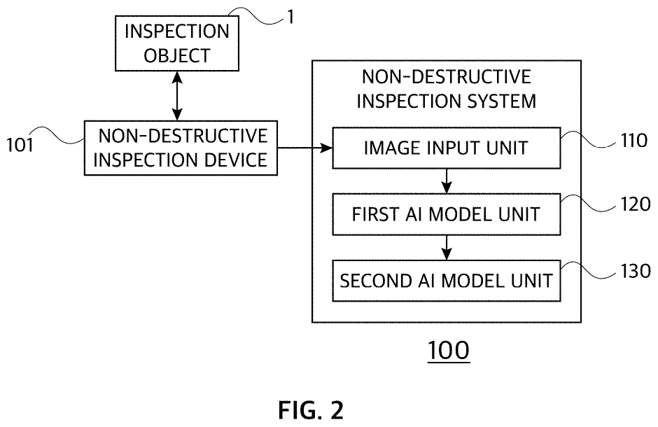

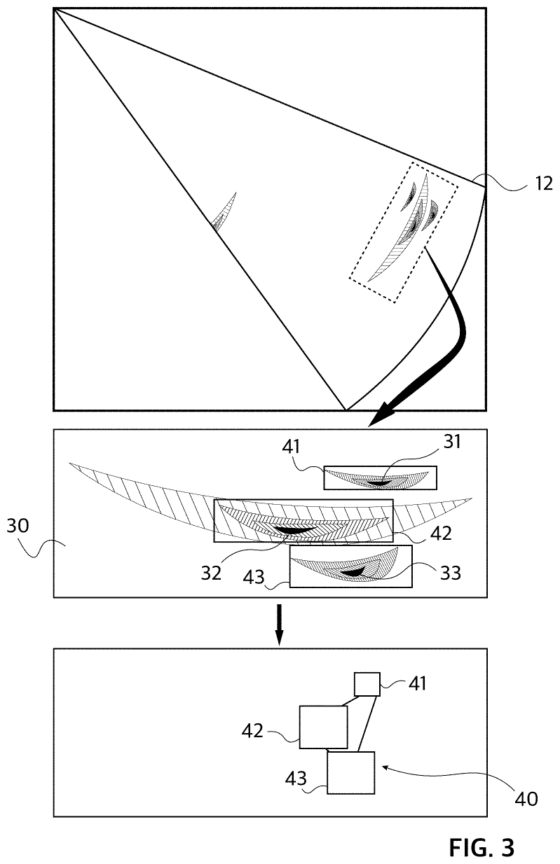

FIG. 1 (b) is a view illustrating inspection signal image data of an inspection object with defects, according to an embodiment of the present disclosure. FIG. 2 is a block diagram of a non-destructive inspection system using an artificial intelligence (AI) model, according to an embodiment of the present disclosure, and FIG. 3 is a view illustrating a processing procedure of the non-destructive inspection system using an AI model, according to an embodiment of the present disclosure.

Referring to FIGS. 1 through 3, a non-destructive inspection system 100 using an AI model according to an embodiment of the present disclosure is an inspection system for determining a defect of an inspection object 1 by analyzing inspection signal image data 11 and 12 generated by a non-destructive inspection device 101 that performs non-destructive inspection on the inspection object 1, and may include an image input unit 110, a first AI model unit 120, and a second AI model unit 130.

The non-destructive inspection device 101 may include a device that performs liquid penetrant examination, magnetic particle testing, radiographic testing, ultrasonic testing, and eddy current testing.

According to the present embodiment, the non-destructive inspection device 101 is described as an ultrasonic testing device, but the present disclosure is not limited thereto. The non-destructive inspection device 101 may be any device that performs non-destructive inspection.

In addition, the non-destructive inspection device 101 may be included in the non-destructive inspection system 100.

When an inspector performs non-destructive inspection on the inspection object 1 through the non-destructive inspection device 101, the non-destructive inspection device 101 may generate the inspection signal image data 11 and 12, as shown in FIG. 1.

For example, because a root part of blades of a turbine used in a power plant is connected to a disk, stress is concentrated and thus a fatigue strength is increased. Accordingly, stress corrosion may occur and micro cracks may be generated. The inspector may perform non-destructive inspection on the turbine blade root part (inspection object) by using the non-destructive inspection device 101. At this time, the non-destructive inspection device 101 may generate the inspection signal image data 11 shown in FIG. 1 (a), when the turbine blade root part has no cracks, and may generate the inspection signal image data 12 shown in FIG. 1 (b), when the turbine blade root part has a crack.

In the conventional art, an inspector determines whether a turbine blade is defective, by directly checking FIG. 1 (a) or FIG. 1 (b), which is the inspection signal image data generated by the non-destructive inspection device 101, with his or her eyes. However, the quality of an inspection result is not uniform because the inspection result varies depending on the inspector's individual ability such as the inspector's qualification, experience, and education level.

The non-destructive inspection system 100 based on the AI model according to the present disclosure is provided to prevent this problem, and may receive the inspection signal image data 11 and 12 generated by the non-destructive inspection device 101, and analyze the received inspection signal image data 11 and 12 by using the AI model to determine a defect in the inspection object 1 such as a turbine blade.

The inspection object 1 may be any inspection object on which non-destructive inspection may be performed.

The image input unit 110 according to an embodiment of the present disclosure is provided to receive the inspection signal image data 11 and 12 of the inspection object 1, and the received inspection signal image data 11 and 12 may be transmitted to the first AI model unit 120.

The image input unit 110 may rescale the shapes of the received image data 11 and 12 to square shapes so as to adjust an image size for easy identification by the inspector.

The first AI model unit 120 is provided to extract feature portions 31, 32, and 33 from the inspection signal image data 11 and 12.

The feature portions 31, 32, and 33, which are regions essential for defect detection and determination in the inspection signal image data 11 and 12 generated by the non-destructive inspection device 101, may be portions in which the output strength of an inspection signal is relatively high compared to other regions. As shown in FIG. 3, the inspection signal image data 11 and 12 may appear in different colors according to output strengths of inspection signals, and the feature portions 31, 32, and 33 may appear in a contrasting color with a region 30 where the output of an inspection signal is weak.

The second AI model unit 130 is provided to generate node relationship information 40 by converting the feature portions 31, 32, and 33 into nodes 41, 42, and 43, respectively, and determine whether the inspection object 1 is defective, based on the generated node relationship information 40, and thus may be trained with the node relationship information 40 to determine whether the inspection object 1 is defective.

The second AI model unit 130 may generate the nodes 41, 42, and 43 respectively including the feature portions 31, 32, and 33, and may generate the node relationship information 40 by using relative location information of the generated nodes 41, 42, and 43. The node relationship information 40 may be relationship information including relative locations between the nodes 41, 42, and 43 and distances between the nodes 41, 42, and 43.

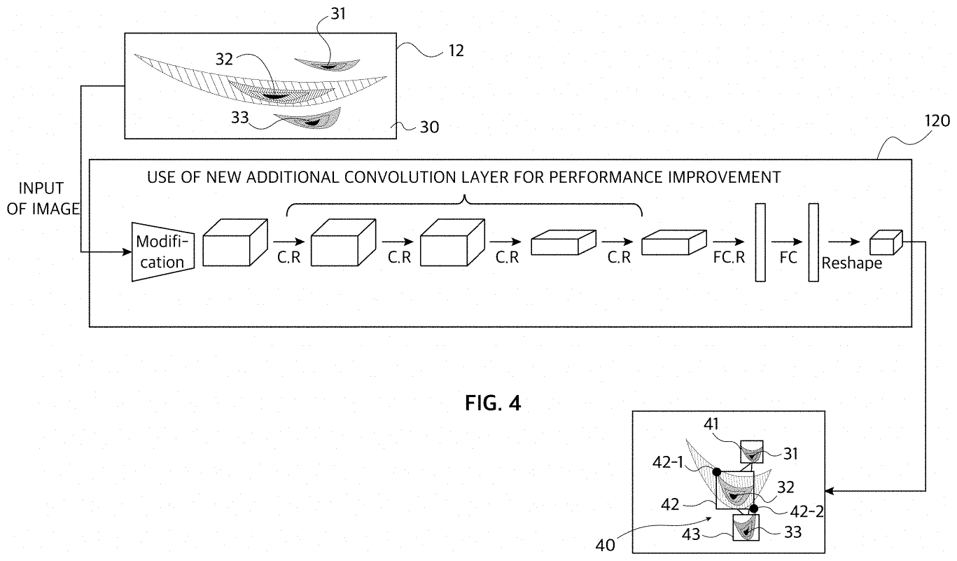

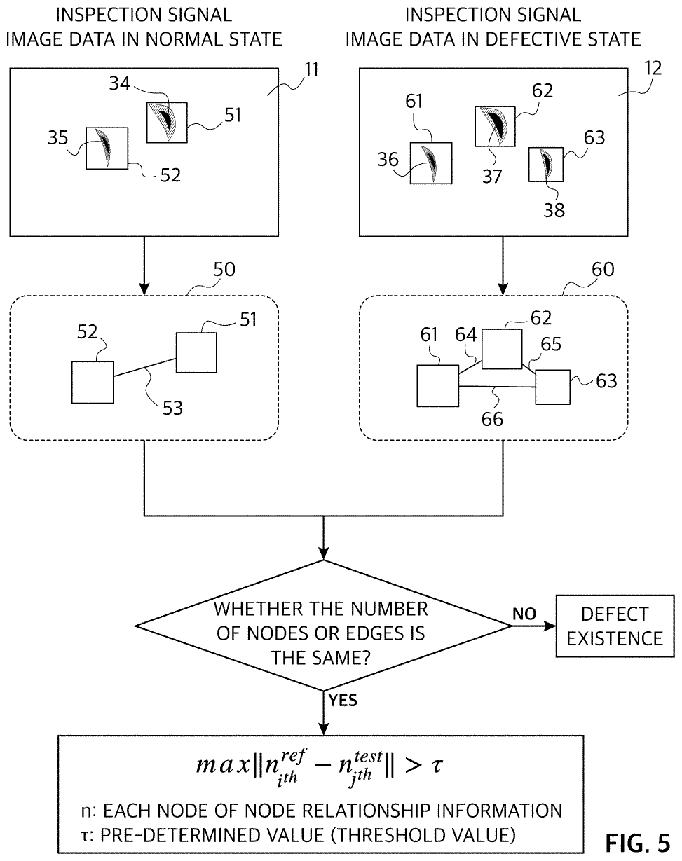

FIG. 4 is a diagram illustrating a first AI model of a non-destructive inspection system based on an AI model according to an embodiment of the present disclosure, and FIG. 5 illustrates a determination flow of a second AI model unit with respect to a defect of an inspection object, according to an embodiment of the present disclosure.

Referring to FIGS. 2 through 5, the first AI model unit 120 of the non-destructive inspection system 100 based on an AI model according to an embodiment of the present disclosure may be a model trained with a deep neural network (DNN) in which a plurality of convolution layers are combined.

In response to the inspection signal image data 12 for determining a defect, the first AI model unit 120 may adjust the brightness of the inspection signal image data 12 so that the feature portions 31, 32, and 33 contrast more strongly than the other region 30, by using the DNN. Because the feature portions 31, 32, and 33 contrast more strongly than the other region 30, extraction accuracy of the feature portions 31, 32, and 33 may be further improved.

Although the brightness of the inspection signal image data 12 is adjusted by the first AI model unit 120 in the present embodiment, the image input unit 110 may adjust the brightness of the received inspection signal image data 12, and the first AI model unit 120 may perform a function of extracting the feature portions 31, 32, and 33.

The first AI model unit 120 may extract the feature portions 31, 32, and 33 necessary for detecting a defect of an inspection object from the entire inspection signal image data 12 by using the DNN. In the non-destructive inspection system 100, the first AI model unit 120 extracts a region that is meaningful for the defect detection, and thus processing efficiency may be improved.

The second AI model unit 130 may extract a partial region as a rectangular region so as to include the feature portions 31, 32, and 33 and convert the extracted region into the nodes 41, 42, and 43, by using image data of the feature portions 31, 32, and 33 adjusted and extracted by the first AI model unit 120. Thereafter, when the nodes 41, 42, and 43 do not have square shapes, the second AI model unit 130 may rescale the nodes 41, 42, and 43 to have square shapes and may generate the node relationship information 40. The second AI model unit 130 may normalize or standardize a node relationship shape by rescaling the nodes 41, 42, and 43 to square shapes, thereby improving defect detection accuracy.

In this case, the second AI model unit 130 may detect location information about each of the nodes 41, 42, and 43. For example, by detecting location information of opposite corners 42-1 and 42-2 among the corners of the node 42, the second AI model unit 130 may ascertain respective locations of the nodes 41, 42, and 43 and may calculate relative location relationships between the nodes 41, 42, and 43.

Referring to FIG. 5, the second AI model unit 130 according to an embodiment of the present disclosure may be trained based on a plurality of pieces of node relationship information to receive new node relationship information for determination and determine whether an inspection object is defective. The second AI model unit 130 may use a first algorithm and a second algorithm to determine a defect.

The first algorithm is an algorithm for determining a defect in the inspection object by using intuitive information in pieces of node relationship information 50 and 60. The intuitive information may be the number of nodes or edges in the node relationship information pieces 50 and 60.

The second algorithm is an algorithm that uses non-intuitive information to determine a defect, when it is not possible to determine a defect in the inspection object by using the intuitive information. The non-intuitive information, which is relative location information between nodes 51, 52, 61, 62, and 63 in the node relationship information pieces 50 and 60, may include one or more of a distance between the nodes 51, 52, 61, 62, and 63, respective locations of the nodes 51, 52, 61, 62, and 63, respective distribution shapes of the nodes 51, 52, 61, 62, and 63, and the number of edges 53, 64, 65, and 66 formed between the nodes 51, 52, 61, 62, and 63. The second algorithm may be an algorithm for determining that the inspection object has a defect, when Inequality 1 below is satisfied using the non-intuitive information about the node relationship information pieces 50 and 60.

max∥nᵢₜₕ^{ref}−nⱼₜₕ^{test}∥>τ [Inequality 1]

Inequality 1 is an inequality for confirming that a largest value among the values of distances between nodes exceeds a predetermined threshold value T.

In other words, the second algorithm may be an algorithm that determines that a defect exists, when a largest value among the values of distances between the nodes 51, 52, 61, 62, and 63 exceeds the predetermined threshold value T, by using Inequality 1.

The second AI model unit 130 may preferentially determine a defect, based on the first algorithm, in response to the node relationship information pieces 50 and 60, and may detect a defect not detected by the first algorithm by performing a more detailed analysis by using the second algorithm.

For example, when the second AI model unit 130 generates the node relationship information pieces 50 and 60 from the inspection signal image data 11, the second AI model unit 130 may first determine whether the inspection object is defective, by using the first algorithm. Based on the number of nodes 51 and 52 of the generated first node relationship information 50 or the number of nodes 61, 62, and 63 of the generated second node relationship information 60, the second AI model unit 130 may determine the first node relationship information 50 as an inspection object in a normal state and determine the second node relationship information 60 as an inspection object in a defective state.

The second AI model unit 130 may re-determine whether a defect exists, in more detail, by applying the second algorithm to the first node relationship information 50 determined to be normal in the first algorithm. At this time, the second AI model unit 130 may calculate distances between the nodes 51 and 52 by using Inequality 1, and, when a largest value among the values of the calculated distances exceeds the predetermined threshold value T, may determine that the first node relationship information 50 is defective, and, when the largest value among the values of the calculated distances does not exceed the predetermined threshold value T, may determine that the first node relationship information 50 is normal.

The second AI model unit 130 may save computing resources used for defect determination by performing simple defect determination through the first algorithm and applying the second algorithm to more complex defect determination.

The predetermined threshold value T of the second AI model unit 130 may vary according to settings. The figure of the predetermined threshold value T is a variable that affects the inspection precision and accuracy. When the figure of the predetermined threshold value T is small, the inspection precision may increase but the inspection accuracy may decrease. On the other hand, when the figure of the predetermined threshold value T is large, the inspection precision may decrease but the inspection accuracy may increase.

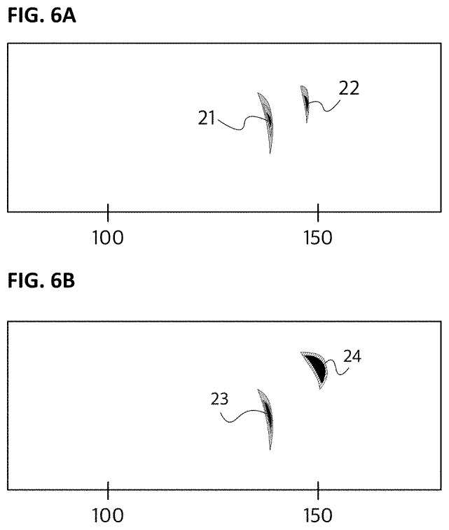

FIG. 6 is a view illustrating different inspection signal image data for the same inspection object in the conventional art.

Referring to FIG. 6, in the conventional art, even when non-destructive inspection is performed on the same inspection object, different inspection signal image data may be obtained according to inspectors. FIGS. 6 (a) and 6 (b) illustrate feature portions 21, 22, 23, and 24 that are inspection signal image data for the same inspection object but have phase differences even on the same X-axis coordinates and have different output strengths. Due to human errors caused by a person who performs such non-destructive inspection signal measurement, simple comparison between inspection signal image data has a high possibility of making errors in inspection. In the present disclosure, rather than an inspector directly determining a defect, the first AI model unit 120 and the second AI model unit 130 convert inspection signal image data into node relationship information and perform defect determination based on the node relationship information, thereby reducing a noise information effect caused due to human factors and thus increasing the inspection reliability.

A non-destructive inspection method using an AI model will now be described. Redundant descriptions given with reference to the non-destructive inspection system using the AI model will be omitted in the below description.

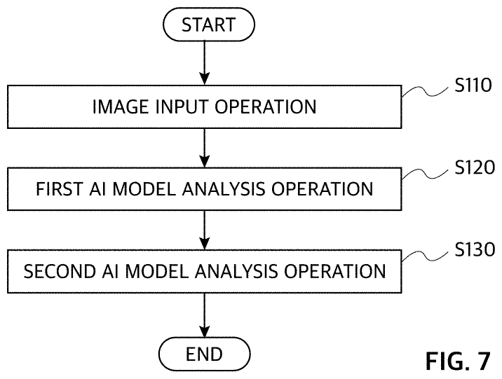

FIG. 7 is a flowchart of a non-destructive inspection method based on an AI model, according to an embodiment of the present disclosure.

Referring to FIGS. 3 and 7, the non-destructive inspection method based on an AI model according to an embodiment of the present disclosure may include an image reception operation S110, a first AI model analysis operation S120, and a second AI model analysis operation S130.

According to the present embodiment, the image reception operation S110 may be an operation of receiving the inspection signal image data 11 and 12 of the inspection object.

In the first AI model analysis operation S120, the one or more feature portions 31, 32, and 33 for determining a defect of the inspection object may be extracted from the inspection signal image data 11 and 12.

In the first AI model analysis operation S120, the brightness of the inspection signal image data 11 and 12 may be adjusted so that the feature portions 31, 32, and 33 are emphasized.

In the first AI model analysis operation S120, the feature portions 31, 32, and 33 may be generated using a DNN in which a plurality of convolution layers are combined.

The feature portions 31, 32, and 33 may be determined based on the output strengths of inspection signals in the inspection signal image data 11 and 12.

In the second AI model analysis operation S130, the feature portions 31, 32, and 33 may be converted into the nodes 41, 42, and 43, respectively, to generate the node relationship information 40, and a defect of the inspection object may be determined through training based on the node relationship information 40.

The nodes 41, 42, and 43 may be generated by extracting rectangular regions respectively including the feature portions 31, 32, and 33.

The node relationship information 40 may include one or more of the number of nodes 41, 42, and 43 and relative location information between the nodes 41, 42, and 43.

In the second AI model analysis operation S130, the shapes of the nodes 41, 42, and 43 may be rescaled to square shapes.

In the second AI model analysis operation S130, the defect of the inspection object may be determined based on the number of nodes 41, 42, and 43 of the node relationship information 40.

In the second AI model analysis operation S130, the defect of the inspection object may be determined based on the relative location information of the nodes 41, 42, and 43. In detail, in the second AI model analysis operation S130, distances between the nodes 41, 42, and 43 may be calculated, and, when a largest value among the values of the calculated distances between the nodes 41, 42, and 43 exceeds a predetermined value, it may be determined that a defect exists in the inspection object.

In a non-destructive inspection system and a non-destructive inspection method both based on an AI model according to the present disclosure, only a specific signal essential for defect determination analysis may be detected from collected inspection signal image data by using the AI model, thereby reducing a computational processing load.

In addition, a human error of an inspector may be excluded by converting the detected signal into node relationship information, and thus more objective and accurate defect detection may be achieved.

Moreover, because a series of non-destructive inspection processes may be automated, the non-destructive inspection time may be reduced, leading to an increase in the efficiency of non-destructive inspection.

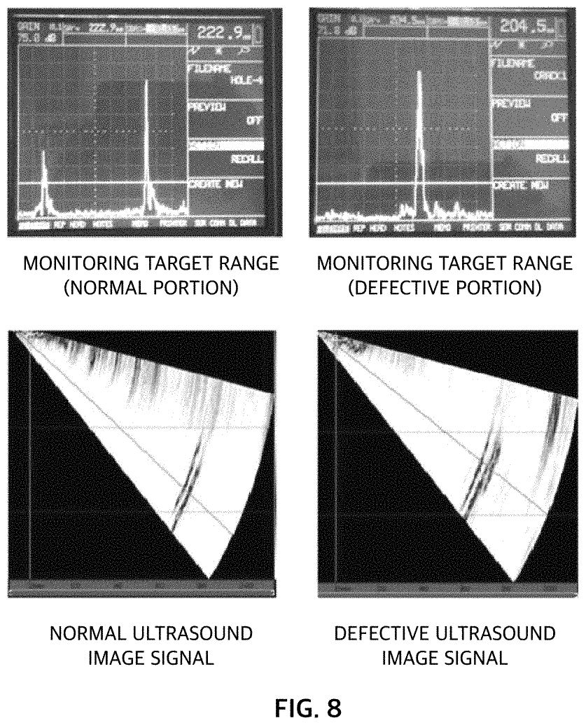

FIG. 8 illustrates ultrasound waveforms and image signals obtained by visualizing signals acquired by a conventional ultrasonic testing device.

Referring to FIG. 8, the conventional ultrasonic testing device visualizes data so that an inspector may determine a defect of an inspection object. The inspector directly determines the defect of the inspection object by checking the visualized data. In an AI-based non-destructive inspection system according to the present disclosure, an inspector's direct determination is excluded to improve the reliability and precision of an inspection determination result, and an AI model trained through machine learning is a device for reviewing the stability of a non-destructive inspection object, based on the data.

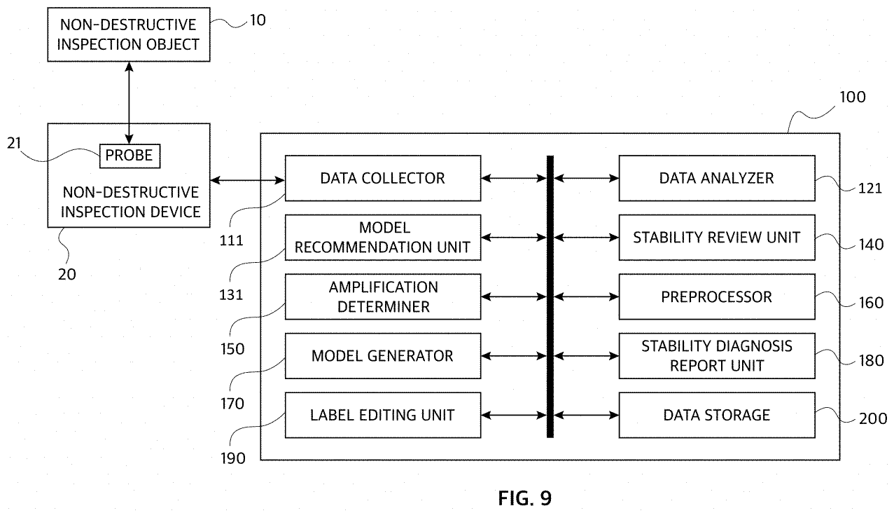

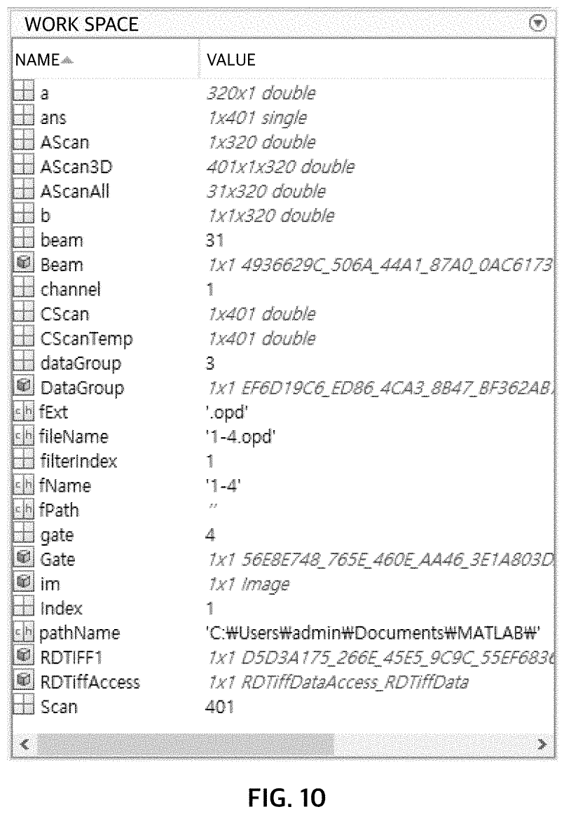

FIG. 9 is a block diagram of an AI-based non-destructive inspection system according to an embodiment of the present disclosure and its internal structure, and FIG. 10 is a view illustrating a raw data structure of a non-destructive inspection device according to an embodiment of the present disclosure.

Referring to FIG. 9, an AI-based non-destructive inspection system 100 according to an embodiment of the present disclosure is a system for reviewing the stability of a non-destructive inspection object 10 of a non-destructive inspection device 20 by using an AI model based on scan data for the non-destructive inspection object 10, and may include a data collector 111, a data analyzer 121, a model recommendation unit 131, and a stability review unit 140. The AI-based non-destructive testing system 100 according to an embodiment of the present disclosure may further include one or more of an amplification determiner 150, a preprocessor 160, a model generator 170, a stability diagnosis report unit 180, a label editing unit 190, and a data storage 200. The components shown in FIG. 9 are not essential in configuring the AI-based non-destructive inspection system 100, and the AI-based non-destructive inspection system 100 described herein may have more or less components than those listed above.

According to the present embodiment, the data collector 111 may collect raw data generated by the non-destructive inspection device 20. The data analyzer 121 may analyze the characteristics of the raw data and may estimate the non-destructive inspection object 10 according to the characteristics of the raw data. The model recommendation unit 131 may recommend an AI model suitable for the estimated non-destructive inspection object 10. The stability review unit 140 may review the stability of the non-destructive inspection object 10 by using the recommended AI model.

The amplification determiner 150 may determine whether data is amplified to train the recommended AI model recommended according to the characteristics of the raw data. The preprocessor 160 may additionally generate the data when the amplification is necessary. The model generator 170 may generate the AI model through machine learning, and the stability diagnosis report unit 180 may request additional determination by an inspector according to the accuracy of a review result for the stability and may update the review result with a result of the additional determination by the inspector. The stability diagnosis report unit 180 may provide a diagnosis result report including the review result of the stability review unit 140. The label editing unit 190 may perform data labeling for adjusting the weight of the AI model, based on the updated review result. The data storage 200, which is a data storage space, may store raw data collected in the past, data used for analysis and learning, and diagnosis result reporters issued by the stability diagnosis report unit 180, and may also store data and newly-collected raw data to be used for future non-destructive inspection reviews.

The non-destructive inspection device 20 according to an embodiment of the present disclosure may be an inspection device using ultrasonic waves. According to the present embodiment, the non-destructive inspection device 20 may transmit ultrasonic waves to the non-destructive inspection object 10 through a probe 21, detect the ultrasonic waves returned to the probe 21, and generate raw data, based on the detected ultrasonic waves. The raw data may refer to data generated by organizing measured values (data) of the non-destructive inspection device 20 in the structure of a preset data set. The raw data may have different characteristics according to the types of the non-destructive inspection device 20. For example, the non-destructive inspection device 20 having the characteristics of performing 401 ultrasound measurements at 31 points at a single angle and using an average value of results of the 401 ultrasound measurements may generate raw data having the data structure of FIG. 10 as its characteristics. In other words, the characteristics of the raw data may denote the structure of the raw data, and the characteristics of the raw data may vary according to the characteristics of each type of the non-destructive inspection device 20.

The data collector 111 may collect the raw data from the non-destructive inspection device 20. The data collector 111 may collect the raw data in real time or non-real time. When a network connection is not possible according to a data collection environment, the data collector 111 may collect the raw data through a separate data storage medium. The collected raw data may be stored in the data storage 200. The raw data collected by the data collector 111 may be used as training data for machine learning by the model generator 170.

The data analyzer 121 may parse and analyze the collected raw data to estimate a non-destructive inspection object through the characteristics of the raw data. For example, the data analyzer 121 may parse and analyze the raw data as shown in FIG. 10 to recognize the structure and characteristics of the raw data, and may estimate the non-destructive inspection object 10 through comparison with previous measured data stored in the data storage 200.

The model recommendation unit 131 may recommend an AI model suitable for the stability review of the non-destructive inspection object 10 among a plurality of pre-registered AI models, based on the estimated non-destructive inspection object 10 and the characteristics of the raw data.

Because there are various types of non-destructive inspection devices 20, the raw data generated by the non-destructive inspection device 20 may have various characteristics. Therefore, an appropriate AI model needs to be selected according to the characteristics of the raw data. For example, the appropriate AI model may be an AI model to which a classification method according to the characteristics of the raw data has been applied, or may be an AI model to which a clustering method has been applied.

The stability review unit 140 may review the stability of the non-destructive inspection object 10 by using the recommended AI model.

The amplification determiner 150 may derive whether the recommended AI model is overfitted or the determination accuracy of the recommended AI model, and may determine stability inspection performance of the AI model with respect to the non-destructive inspection object 10, based on whether the recommended AI model is overfitted or the determination accuracy of the recommended AI model. When it is determined that the stability inspection performance of the recommended AI model is low, the amplification determiner 150 may determine that data amplification is necessary. The preprocessor 160 may additionally generate the data when the amplification is necessary.

In general, because a power generation turbine or drive system of a large-scale plant is unable to arbitrarily stop an operation of equipment in order to secure data, the power generation turbine or drive system has to restrictively collect data according to a set inspection schedule. Therefore, a conventional AI-based non-destructive inspection system that inspects a power generation turbine or drive system of a large-scale plant does not secure enough training data to train the parameters of an AI model, and the AI model trained with small training data is overfitted or a problem occurs in the determination accuracy. In order to prevent this problem, the amplification determiner 150 of the AI-based non-destructive inspection system 100 according to the present disclosure determines whether the AI model is overfitted or whether a problem occurs in the determination accuracy. When the amplification determiner 150 determines that the AI model is overfitted or there is a problem in the determination accuracy, the preprocessor 160 may amplify the data in order to address overfitting of the AI model or improve the determination accuracy. A detailed description of the data amplification will be given later.

When the preprocessor 160 amplifies the data, the model generator 170 may create a new AI model by using the amplified data as training data. When a new AI model is created, the stability review unit 140 may review the stability of a non-destructive inspection object by using the new AI model. As such, the AI-based non-destructive inspection system 100 may improve the determination accuracy of the non-destructive inspection system by generating training data by amplifying the data by itself, even when an initial determination accuracy is low due to a lack of training data.

The stability diagnosis report unit 180 may provide a diagnosis result report including the review result of the stability review unit 140. At this time, the stability diagnosis report unit 180 may request additional determination by an inspector, when the accuracy of the review result of the stability review unit 140 is lower than a pre-determined threshold value.

The inspector may check the diagnosis result report, and, according to a request of the stability diagnosis report unit 180, may input additional determination on the review result of the stability review unit 140 to the AI-based non-destructive inspection system 100. The stability diagnosis report unit 180 may update the review result with a result of the additional determination by the inspector.

Based on the updated review result, the label editing unit 190 may perform data labeling for adjusting the weight of the AI model. The model generator 170 may re-generate an AI model, based on a corrected weight. The AI-based non-destructive inspection system 100 may use the re-generated AI model for later stability review of the same non-destructive testing object. Through this process, the AI-based non-destructive inspection system 100 may obtain the inspector's determination criteria, and may more accurately determine the stability of the non-destructive inspection object.

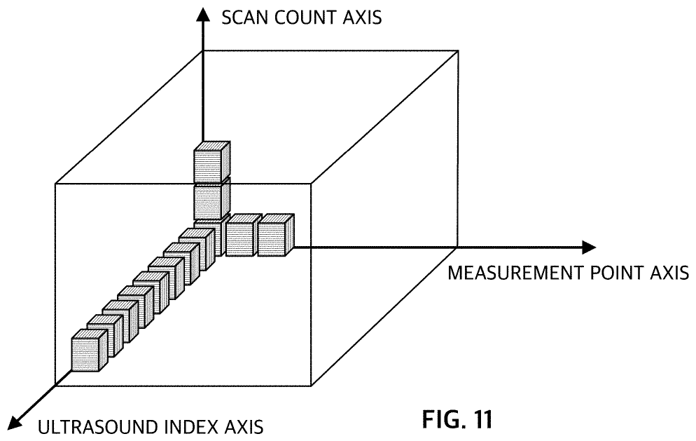

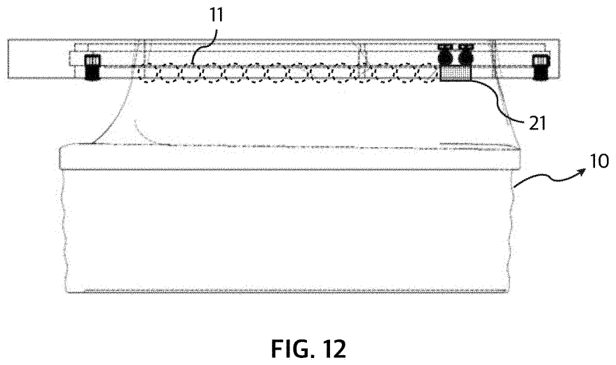

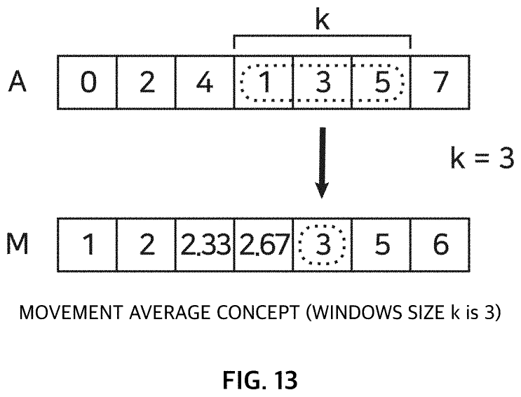

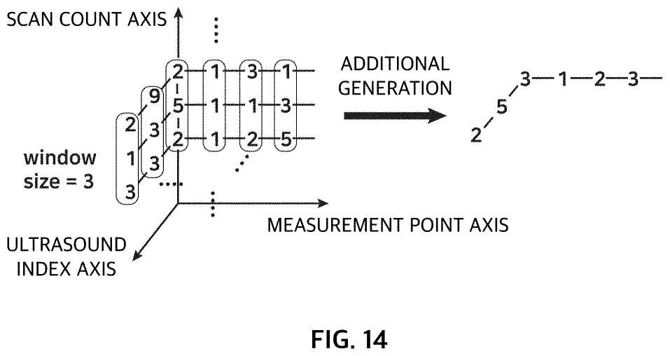

FIG. 11 is a diagram illustrating a three-dimensional (3D) data structure that a data collector collects from raw data, according to an embodiment of the present disclosure, and FIG. 12 is a view illustrating a measurement point of a probe with respect to a non-destructive inspection object according to an embodiment of the present disclosure. FIG. 13 is a diagram illustrating a movement average calculation concept according to an embodiment of the present disclosure, and FIG. 14 is a diagram illustrating data amplification using a movement average in a 3D data structure according to an embodiment of the present disclosure.

Referring to FIG. 11, according to the present embodiment, the data collector 111 may collect data in a 3D data structure having a scan count axis, a measurement point axis, and an ultrasound index axis from the raw data at a single scan angle to facilitate data amplification. The single scan angle may refer to one of the incidence angles of a plurality of ultrasonic waves transmitted by the non-destructive inspection device 20 from one measurement point to a non-destructive inspection object. According to the present embodiment, the non-destructive inspection device 20 may inspect the non-destructive inspection object 10 at various measurement points by using the probe 21. For example, as shown in FIG. 12, the probe 21 may automatically move with respect to the non-destructive inspection object 10 to perform ultrasonic testing at a plurality of measurement points. The properties of measurement points may be included in the raw data, and the data collector 111 may collect the data by using the properties of the measurement points.

According to the present embodiment, the non-destructive inspection device 20 may perform repetitive measurements in the range of about 30 degrees for each measurement point. For example, the non-destructive inspection device 20 may have a measurement range from 40 degrees to 70 degrees, and may perform measurement by generating 400 ultrasonic waves per degree within the measurement range. The 3D data shown in FIG. 11 is data measured at a specific single angle (e.g., 52 degrees). In other words, the data collector 111 may have respective properties for the number of scans, the measurement point, and the ultrasound array index with respect to the value of one piece of data of a single scan angle, and may implement the data in the 3D data structure of FIG. 11 when the data is shown in three dimensions in which each property is represented as one axis.

When the amplification determiner 150 determines that data amplification is necessary, the preprocessor 160 may amplify the data. The amplification of the data may refer to additional generation of data based on the collected data. According to the present embodiment, the preprocessor 160 may additionally generate data by calculating a movement average of adjacent measured values based on any one of a scan count axis, a measurement point axis, and an ultrasound index axis based on 3D data having the scan count axis, the measurement point axis, and the ultrasound index axis. In this case, the preprocessor 160 may adjust a movement average length (window size) used for calculating the movement average, according to the accuracy of the AI model.

Referring to FIG. 13, the movement average may refer to moving data subsets (windows) as much as a movement average length value k with respect to the entire data set and calculating an average for the data subsets.

Describing, referring to FIG. 14, generation of additional data based on the scan count axis when the movement average length is set as 3, the preprocessor 160 may generate new additional data by calculating an average for each of data (measurement point×ultrasound index) of 3^{rd} to 5^{th} scans, an average for each of data of 4^{th} to 6^{th} scans, and an average for each of data of 6^{th} and 7^{th} scans. In this manner, the preprocessor 160 may also additionally generate data based on the measurement point axis or the ultrasound index axis, and thus the AI-based non-destructive inspection system 100 may generate and learn a sufficiently large amount of additional data even with a small amount of data, thereby training an AI model with high accuracy.

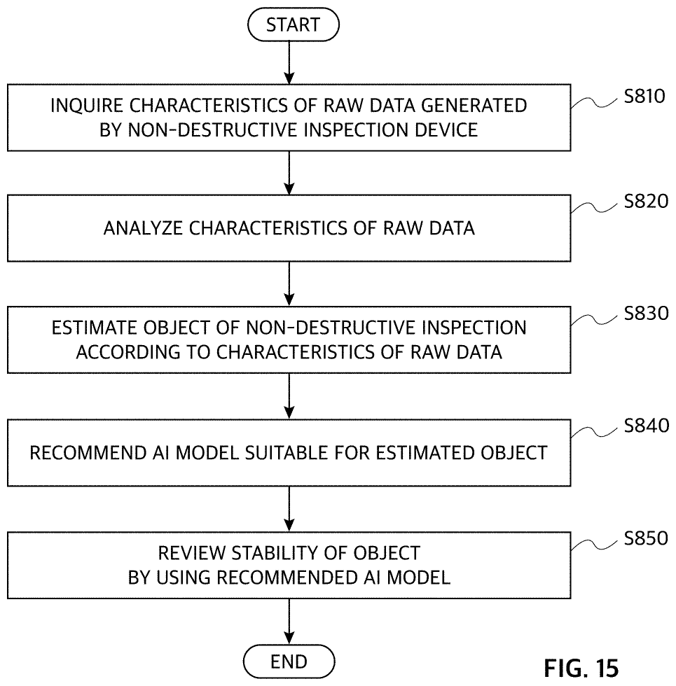

FIGS. 15 through 17 are flowcharts of an AI-based non-destructive inspection method according to an embodiment of the present disclosure.

Referring to FIG. 15, the AI-based non-destructive inspection method according to an embodiment of the present disclosure includes an operation S810 of inquiring the characteristics of raw data generated by a non-destructive inspection device, an operation S820 of analyzing the characteristics of the raw data, an operation S830 of estimating an object of non-destructive inspection according to the characteristics of the raw data, an operation S840 of recommending an AI model suitable for the estimated object, and an operation S850 of reviewing the stability of the object by using the recommended AI model.

In operation S810 of inquiring the characteristics of the raw data, data parsing may be performed based on the raw data and the parsed data may be analyzed.

When the characteristics of the raw data are received from the non-destructive inspection device in operation S810 of inquiring the characteristics of the raw data, a suitable AI model may be recommended among a plurality of pre-registered AI models, based on the received characteristics of the raw data, in operation S840 of recommending the AI model.

The characteristics of the raw data may include structure information of the data obtained by the non-destructive inspection device.

According to the present embodiment, the object may be a turbine blade.

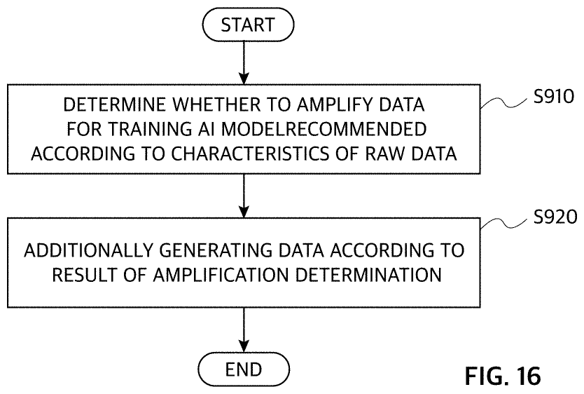

Referring to FIG. 16, the AI-based non-destructive inspection method according to an embodiment of the present disclosure may further include an operation S910 of determining whether to amplify data for training the AI model recommended according to the characteristics of the raw data, and an operation S920 of additionally generating the data according to a result of the amplification determination.

In the operation S910 of determining whether to amplify data, it may be determined whether the data is amplified, according to whether the AI model is overfitted or how the determination accuracy is.

According to the present embodiment, the non-destructive testing device may be an inspection device using ultrasonic waves, and, in the operation S920 of additionally generating the data, the data may be additionally generated by calculating a movement average of adjacent measured values based on any one of a scan count axis, a measurement point axis, and an ultrasound index axis based on 3D data having the scan count axis, the measurement point axis, and the ultrasound index axis.

In the operation S920 of additionally generating the data, a movement average length (window size) used for calculating the movement average may be adjusted according to the accuracy of the AI model.

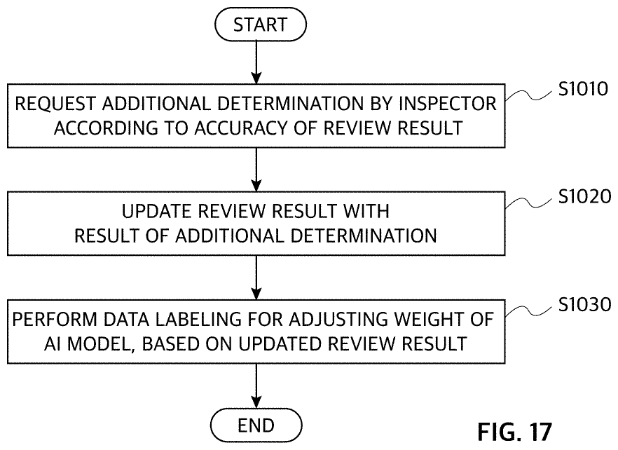

Referring to FIG. 17, the AI-based non-destructive testing method according to an embodiment of the present disclosure may further include an operation S1010 of requesting additional determination by an inspector according to the accuracy of the review result for the stability, an operation S1020 of updating the review result with a result of the additional determination by the inspector, and an operation S1030 of performing data labeling for adjusting the weight of the AI model, based on the updated review result.

In an AI-based non-destructive inspection method according to the present disclosure, determination accuracy may be improved by amplifying data and generating sufficient training data by itself even when sufficient training data is not secured, determination standards of an inspector may be learned, and stability determination may be performed more accurately.

Various embodiments described herein may be implemented by hardware, middleware, microcode, software, and/or combinations thereof. For example, various embodiments may be implemented in one or more application specific semiconductors (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions presented herein, or combinations thereof.

Such hardware, software, firmware, etc. may be implemented in the same device or in separate devices to support the various operations and functions described herein. Additionally, elements, units, modules, components, etc. described as “portions” or “units” in the present disclosure may be implemented together, or may be implemented individually as separate but interoperable logic devices. Depictions of different features of modules, units, etc. are intended to emphasize different functional embodiments, and do not necessarily imply that they must be realized by separate hardware or software components. Rather, functions associated with one or more modules or units may be performed by separate hardware or software components or may be integrated within common or separate hardware or software components.

Although the present disclosure has been described with reference to the embodiments shown in the drawings, this is merely an example. It will be understood by one of ordinary skill in the art that various modifications and equivalent other embodiments may be made without departing from the spirit and scope of the present disclosure as defined by the following claims.

1. A non-destructive inspection system based on an artificial intelligence (AI) model for determining a defect of an inspection object, the non-destructive inspection system comprising:
an image input unit configured to receive inspection signal image data of the inspection object;
a first AI model unit configured to extract one or more feature portions for determining a defect of the inspection object from the inspection signal image data; and
a second AI model unit configured to generate node relationship information by converting each of the feature portions into a node and learn based on the node relationship information to determine a defect in the inspection object.

2. The non-destructive inspection system of claim 1, wherein the one or more feature portions are determined based on output strengths of inspection signals in the inspection signal image data.

3. The non-destructive inspection system of claim 1, wherein the first AI model unit adjusts brightness of the inspection signal image data so that the one or more feature portions are emphasized.

4. The non-destructive inspection system of claim 1, wherein the nodes are generated by extracting rectangular regions respectively including the feature portions.

5. The non-destructive inspection system of claim 4, wherein the second AI model unit rescales shapes of the nodes to square shapes.

6. The non-destructive inspection system of claim 1, wherein the first AI model unit emphasizes the feature portions by using a deep neural network (DNN) in which a plurality of convolution layers are combined.

7. The non-destructive inspection system of claim 1, wherein the node relationship information includes one or more of the number of nodes and relative location information between the nodes.

8. The non-destructive inspection system of claim 1, wherein the second AI model unit determines a defect of the object, based on the number of nodes in the node relationship information.

9. The non-destructive inspection system of claim 8, wherein the second AI model unit determines a defect of the object, based on relative location information between the nodes in the node relationship information.

10. The non-destructive inspection system of claim 9, wherein the second AI model unit calculates distances between the nodes, and, when a largest value among values of the calculated distances between the nodes exceeds a pre-determined value, determines that a defect exists in the inspection object.

11. A non-destructive inspection method based on an artificial intelligence (AI) model for determining a defect of an inspection object, the non-destructive inspection method comprising:
an image reception operation of receiving inspection signal image data of the inspection object;
a first AI model analysis operation of extracting one or more feature portions for determining a defect of the inspection object from the inspection signal image data; and
a second AI model analysis operation of converting each of the feature portions into a node to generate node relationship information and learning based on the node relationship information to determine a defect in the inspection object.

12. The non-destructive inspection method of claim 11, wherein the one or more feature portions are determined based on output strengths of inspection signals in the inspection signal image data.

13. The non-destructive inspection method of claim 11, wherein the first AI model analysis operation includes adjusting brightness of the inspection signal image data so that the one or more feature portions are emphasized.

14. The non-destructive inspection method of claim 11, wherein the nodes are generated by extracting rectangular regions respectively including the feature portions.

15. The non-destructive inspection method of claim 14, wherein the second AI model analysis operation includes rescaling shapes of the nodes to square shapes.

16. The non-destructive inspection method of claim 11, wherein the first AI model analysis operation includes emphasizing the feature portions by using a deep neural network (DNN) in which a plurality of convolution layers are combined.

17. The non-destructive inspection method of claim 11, wherein the node relationship information includes one or more of the number of nodes and relative location information between the nodes.

18. The non-destructive inspection method of claim 11, wherein the second AI model analysis operation includes determining a defect of the object, based on the number of nodes in the node relationship information.

19. The non-destructive inspection method of claim 18, wherein the second AI model analysis operation includes determining a defect of the object, based on relative location information between the nodes in the node relationship information.

20. The non-destructive inspection method of claim 19, wherein the second AI model analysis operation includes calculating distances between the nodes, and, when a largest value among values of the calculated distances between the nodes exceeds a pre-determined value, determining that a defect exists in the inspection object.
